(19) United States
(12) Patent Application Publication
(10) Pub. No.: US 2026/0228454 A1
(43) Pub. Date: Aug. 6, 2026

(54) INFORMATION PROCESSING APPARATUS, INFERENCE METHOD, AND COMPUTER-READABLE RECORDING MEDIUM

(71) Applicant: NEC Corporation, Tokyo (JP)

(72) Inventor: Youki SADA, Tokyo (JP)

(21) Appl. No.: 19/457,403

(22) Filed: Jan. 23, 2026

(30) Foreign Application Priority Data
Feb. 6, 2025 (JP) 2025-018025

(51) Int. Cl. G06F 40/40; G06F 40/284; G06N 5/04

(52) U.S. Cl. CPC G06F 40/40; G06F 40/284; G06N 5/04

(57) ABSTRACT

An information processing apparatus includes a merging unit for executing merging processing on pieces of first merging target information having a key vector and a value vector to be used in target transformer blocks among a plurality of transformer blocks by using learned merging conversion information, and generating merging information obtained by making the pieces of first merging target information common, and an unmerging unit for executing, in next inference, unmerging processing on the merging information by using learned unmerging conversion information, and generating pieces of second merging target information to be used respectively in the target transformer blocks.

### CROSS REFERENCE TO RELATED APPLICATION

This application is based upon and claims the benefit of priority from Japanese patent application No. 2025-018025, filed on Feb. 6, 2025, the disclosure of which is incorporated herein in its entirety by reference.

### TECHNICAL FIELD

The present disclosure relates to an information processing apparatus, an inference method, and a computer-readable recording medium used for a language model.

### BACKGROUND ART

A Large Language Model (LLM) or the like is known as a machine learning model used in natural language processing or the like. The Large Language Model uses a Key Value (KV) cache for each of a plurality of transformer blocks (layers).

As a related technique, PTL 1 (Japanese Patent No. 7527581) infers a next token for an input token by using a query vector, a key vector, and a value vector associated to a latest token and key vectors and value vectors associated to all cached past tokens, in each of transformer blocks. In addition, the key vector (K) and the value vector (V) calculated in each of the transformer blocks are stored in the KV cache. Furthermore, the machine learning model can execute inference processing at high speed by reusing the key vector and the value vector calculated in the past by using the KV cache.

However, in an information processing system of Japanese Patent No. 7527581, the key vector and the value vector are calculated for each transformer block. In addition, since the calculated key vector and value vector are stored in the KV cache, a large amount of memory is used.

### SUMMARY

An example of an object of the present disclosure is to reduce a usage amount of memory used in a language model and reduce an amount of calculation.

In order to achieve the above object, an information processing apparatus in one aspect of the present disclosure
is characterized by including
a merging unit for executing merging processing on pieces of first merging target information having a key vector and a value vector to be used in target transformer blocks among a plurality of transformer blocks by using learned merging conversion information, and generating merging information obtained by making the pieces of first merging target information common, and
an unmerging unit for executing, in next inference, unmerging processing on the merging information by using learned unmerging conversion information, and generating pieces of second merging target information to be used respectively in the target transformer blocks.

In addition, in order to achieve the above object, an inference method in one aspect of the present disclosure
is characterized by including,
by a computer that executes a language model including a plurality of transformer blocks,
executing merging processing on pieces of first merging target information having a key vector and a value vector to be used in target transformer blocks among the plurality of transformer blocks by using learned merging conversion information, and generating merging information obtained by making the pieces of first merging target information common, and
executing, in next inference, unmerging processing on the merging information by using learned unmerging conversion information, and generating pieces of second merging target information to be used respectively in the target transformer blocks.

Furthermore, in order to achieve the above object, a computer-readable recording medium in one aspect of the present disclosure
is characterized by recording a program
for causing a computer that executes a language model including a plurality of transformer blocks to
execute merging processing on pieces of first merging target information having a key vector and a value vector to be used in target transformer blocks among the plurality of transformer blocks by using learned merging conversion information, and generate merging information obtained by making the pieces of first merging target information common, and
execute, in next inference, unmerging processing on the merging information by using learned unmerging conversion information, and generate pieces of second merging target information to be used respectively in the target transformer blocks.

As described above, according to the present disclosure, it is possible to reduce the usage amount of memory used in the language model and reduce the amount of calculation.

### BRIEF DESCRIPTION OF THE DRAWINGS

FIG. 1 is a diagram for explaining an example of an information processing apparatus;

FIG. 2 is a diagram for explaining an example of a configuration and operation of a language model;

FIG. 3 is a diagram for explaining an example of a configuration of a transformer block;

FIG. 4 is a diagram illustrating an example of a system including the information processing apparatus;

FIG. 5 is a diagram for explaining an example of an inference unit;

FIG. 6 is a diagram for explaining an example of inference in detail;

FIG. 7 is a diagram for explaining an example of a calibration unit;

FIG. 8 is a diagram for explaining an example of the calibration unit;

FIG. 9 is a diagram for explaining an example of a learning unit;

FIG. 10 is a diagram for explaining an example of merging and unmerging operation;

FIG. 11 is a diagram for explaining an example of calibration operation;

FIG. 12 is a diagram for explaining an example of learning operation; and

FIG. 13 is a diagram for explaining an example of a computer that implements the information processing apparatus in the example embodiment.

### EXAMPLE EMBODIMENT

Hereinafter, an example embodiment will be described with reference to the drawings. In the drawings to be described below, elements having the same function or relevant functions are denoted by the same reference signs, and repeated description thereof may be omitted.

### Example Embodiment

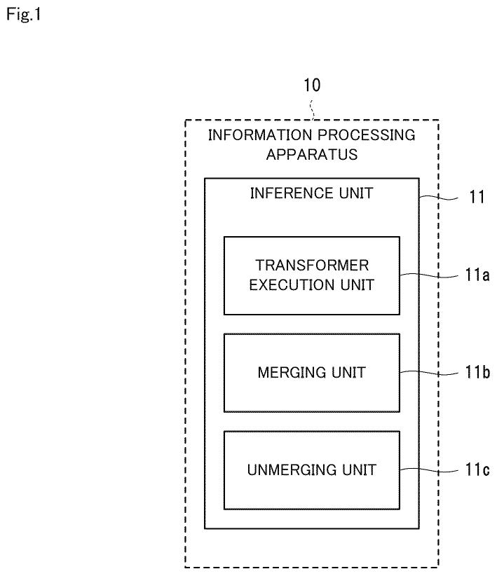

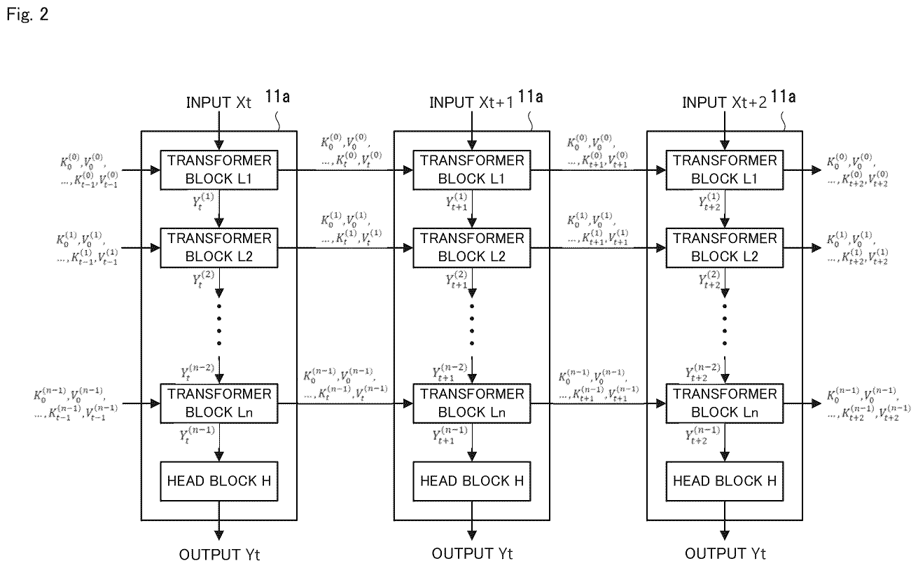

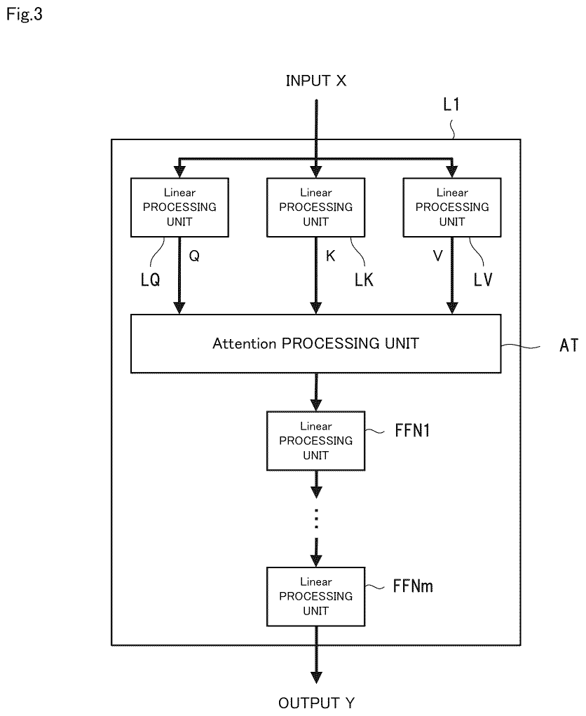

A configuration of an information processing apparatus in the example embodiment will be described, with reference to FIGS. 1, 2, and 3. FIG. 1 is a diagram for explaining an example of the configuration of the information processing apparatus. FIG. 2 is a diagram for explaining an example of a configuration and operation of a language model. FIG. 3 is a diagram for explaining an example of a configuration of a transformer block.

### [Apparatus Configuration]

An information processing apparatus 10 illustrated in FIG. 1 is an apparatus capable of reducing an amount of calculation of a language model and reducing a usage amount of memory. The information processing apparatus 10 includes an inference unit (language model) 11. The inference unit 11 includes a transformer execution unit 11a, a merging unit 11b (merging means), and an unmerging unit 11c (unmerging means).

The transformer execution unit 11a includes a plurality of transformer blocks (layers). The transformer execution unit 11a has, for example, a structure in which several tens to several hundreds of transformer blocks are stacked. Specifically, as illustrated in FIG. 2, the transformer execution unit 11a includes transformer blocks L (L1, L2, . . . , and Ln) and a head block H.

Here, the transformer execution unit 11a executes prefill once and repeatedly executes decode until an answer is ended. For example, in prefill, a prompt is input (Hello! How are you?: inputs X₀, . . . , and X₅), and the first token “Hello” of an answer sentence (Hello! I'm doing great.) is inferred. In decode, a token Yₜ₋₁ inferred from a previous token at t−1 is used as an input, and a token of the answer sentence at tis inferred. For example, in a case where “Hello” of the answer sentence is input, a token “!” is inferred.

FIG. 2 is a general example, and illustrates operations at positions t, t+1, and t+2 during decode. Each of the transformer blocks L1, L2, . . . , and Ln acquires an input X and a key vector K and a value vector V of a KV cache, and outputs an output Y.

A past hidden state (K, V) is set as a cache, and Attention processing is performed by using all the past K and V from the KV cache for each token. For that reason, as the token length is longer (in the case of a long sentence), the usage amount of memory increases.

The head block H is provided at the end of the transformer block and is a linear layer (layer for linearly transforming a vector) for outputting a probability distribution of a next word.

As illustrated in FIG. 3, each of the transformer blocks L1, L2, . . . , and Ln includes a Linear processing unit LQ, a Linear processing unit LK, a Linear processing unit LV, an Attention processing unit AT, and Linear processing units FFN1 to FFNm.

The Linear processing unit LQ calculates a Linear matrix LQ (Q: query) by using an input matrix X and a weight matrix W1 stored in advance in a parameter 21b of a storage device 20. The Linear processing unit LK calculates a Linear matrix LK (K: key) by using the input matrix X and a weight matrix W2 stored in advance in the parameter 21b of the storage device 20. The Linear processing unit LV calculates a Linear matrix LV (V: value) by using the input matrix X and a weight matrix W3 stored in advance in the parameter 21b of the storage device 20.

The Attention processing unit AT is a mechanism that prioritizes a plurality of past hidden states (feature vectors K and V) and determines which hidden state to focus on. Examples of the Attention processing unit AT include dot product Attention. However, the Attention processing unit AT is not limited to dot product Attention.

The Linear processing units FFN1, . . . , and FFNm are Feedforward Networks (FFNs) provided at the subsequent stage of the Attention processing unit AT.

However, only with the conventional language model described above, a parameter (weight) used in each of the transformer blocks (layers) and the key vector K and the value vector V stored in the KV cache use a large amount of memory of a Graphics Processing Unit (GPU). Thus, as illustrated in FIG. 1, the merging unit 11b and the unmerging unit 11c are provided in addition to the transformer execution unit 11a, whereby a usage amount of memory of the key vector K and the value vector V used in the language model is reduced.

The merging unit 11b executes merging processing (compression) on pieces of first merging target information having a key vector and a value vector to be used respectively in target transformer blocks among the plurality of transformer blocks by using learned merging conversion information, and generates merging information obtained by making the pieces of first merging target information common (compressed).

In next inference (decode), the unmerging unit 11c executes unmerging processing (prediction) on the merging information by using learned unmerging conversion information, and generates pieces of second merging target information (predicted key vector and value vector) to be used respectively in the target transformer blocks.

As described above, in the example embodiment, it is possible to make the key vector and the value vector used in the target transformer block common by compressing the key vector and the value vector by the merging processing, so that the usage amount of the memory used in the language model can be reduced. Furthermore, the amount of calculation of the language model can also be reduced.

### [System Configuration]

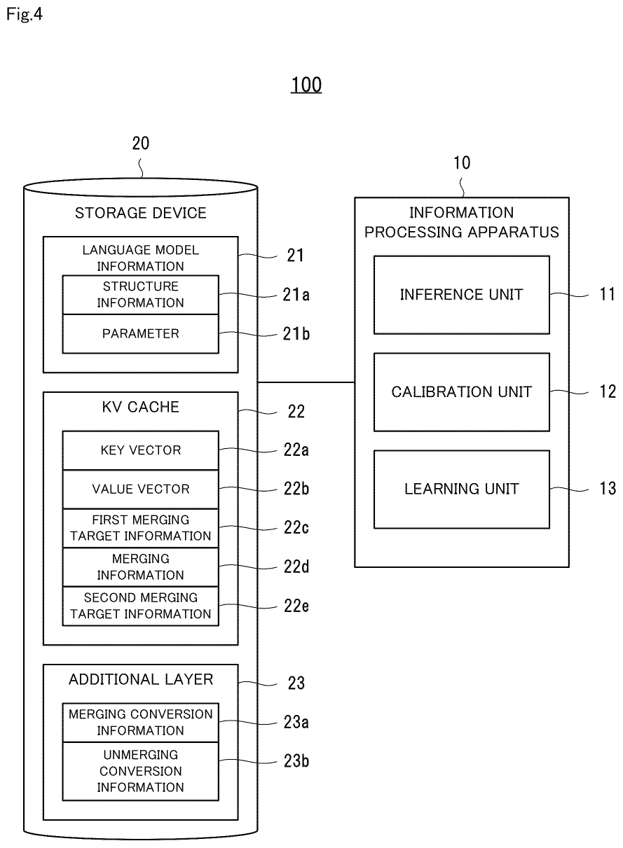

Subsequently, a configuration of the information processing apparatus 10 in the example embodiment will be more specifically described, with reference to FIG. 4. FIG. 4 is a diagram illustrating an example of a system including the information processing apparatus.

As illustrated in FIG. 4, a system 100 in the example embodiment includes the information processing apparatus 10 and the storage device 20.

The information processing apparatus 10 is an apparatus such as a circuit, a server computer, a personal computer, or a mobile terminal, each of which is equipped with, for example, a Central Processing Unit (CPU), a programmable device such as a Field-Programmable Gate Array (FPGA), a GPU, or any one or more thereof.

The information processing apparatus 10 includes an inference unit 11, a calibration unit 12, and a learning unit 13.

The storage device 20 is a database, a server computer, a circuit including a memory, or the like. The storage device 20 is provided outside the information processing apparatus 10 in the example of FIG. 4, but may be provided inside the information processing apparatus 10.

The storage device 20 stores, for example, language model information 21, information stored in a KV cache 22, information stored in an additional layer 23, and the like. However, the KV cache 22 is provided in a memory of the GPU of the information processing apparatus 10.

The language model information 21 includes at least structure information 21a indicating a structure of a language model used to construct the language model, and the parameter 21b such as a weight used in the language model.

The information stored in the KV cache 22 includes at least a key vector 22a (hereinafter, may be referred to as K or K vector), a value vector 22b (hereinafter, may be referred to as V or V vector), first merging target information 22c, merging information 22d, and second merging target information 22e.

The key vector 22a and the value vector 22b represent a key vector and a value vector used in a transformer block other than the target transformer block (transformer block for which merging or unmerging is not performed).

The information stored in the additional layer 23 includes at least merging conversion information 23a and unmerging conversion information 23b.
The inference unit will be described.

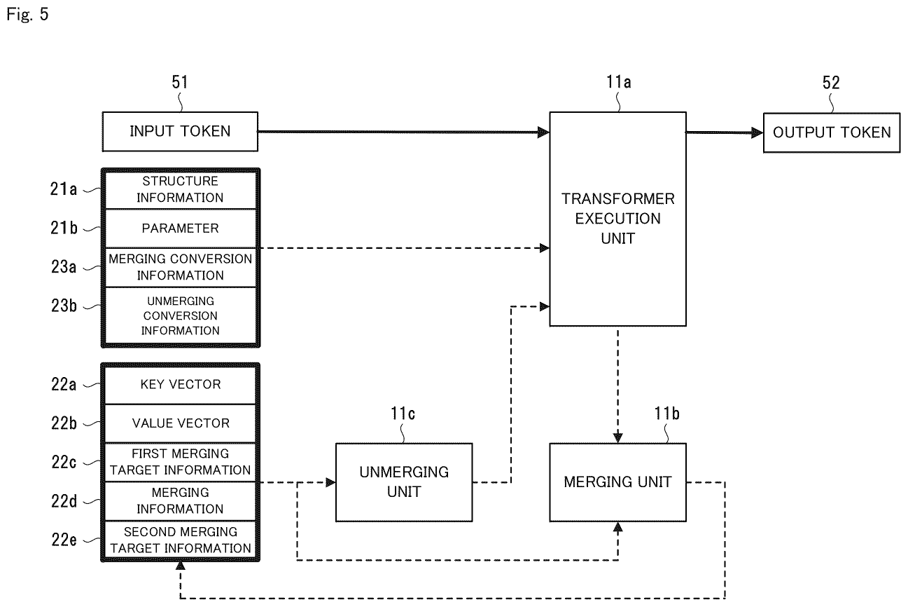

FIG. 5 is a diagram for explaining an example of the inference unit. The inference unit 11 includes the transformer execution unit 11a, the merging unit 11b, and the unmerging unit 11c.

### <Transformer Execution Unit>

When a token (word) is input, the transformer execution unit 11a predicts (infers) a token following the input token. Specifically, as illustrated in FIG. 5, when an input token 51 is input, the transformer execution unit 11a predicts and outputs an output token 52 subsequent to the input token 51.

Unlike the related technique, the transformer execution unit 11a performs conversion (unmerging processing) on the merging information by using learned unmerging conversion information, and predicts the output token 52 by using the key vector and the value vector predicted from the merging information.

The transformer execution unit 11a is constructed based on the language model information 21 (structure information 21a, parameter 21b) and the additional layer 23 (merging conversion information 23a and unmerging conversion information 23b) illustrated in FIG. 5.

### <Merging Unit>

In order to make the description of the merging unit easy to understand, a case where the adjacent transformer blocks Li and Li+1 are targeted will be described as an example.

The merging unit 11b first acquires pieces of first merging target information (key vector and value vector) to be used respectively in the target transformer blocks Li and Li+1. Next, the merging unit 11b concatenates the first merging target information ([Ki], [Vi]) of the transformer block Li and the first merging target information ([Ki+1], [Vi+1]) of the transformer block Li+1 to generate concatenation information. However, the concatenation is performed in a hidden dimension direction.

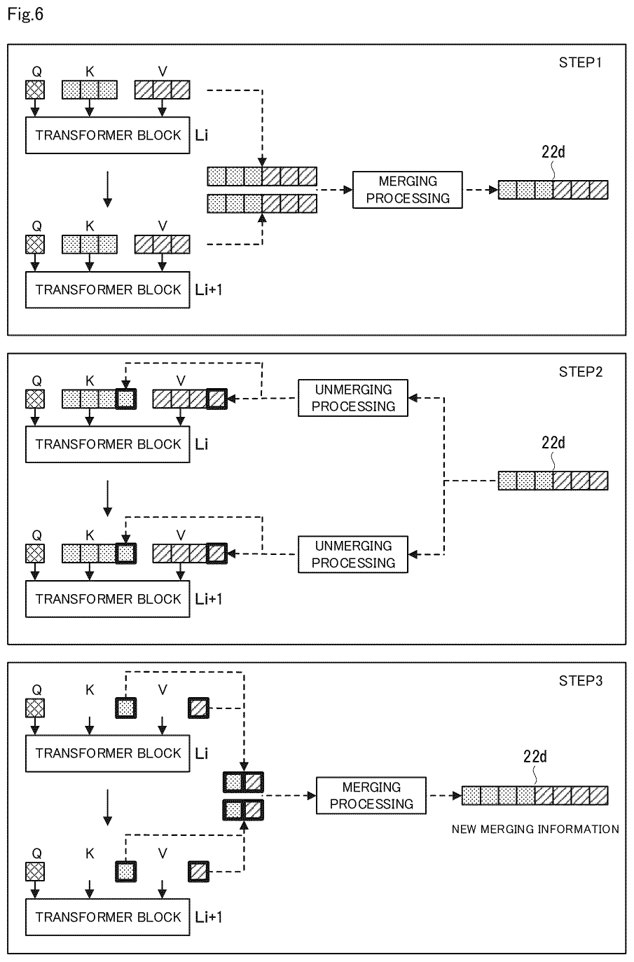

Here, K and V each are two-dimensional (the current number of tokens×the number of hidden dimensions). For example, in a case where the size of the feature vector is 4096, the number of hidden dimensions is (the current number of tokens×8192) after the concatenation. Concatenation information Zk_{i,i+1} and Zv_{i,i+1} can be expressed as Math. 1. In Math. 1, fcat( ) represents a concatenation function. Note that, in step 1 of FIG. 6 described later, the current number of tokens is three.

$$Z {k}_{i , i + 1} = {f}_{cat} ( {K}_{i} , {K}_{i + 1} ) = [ \begin{matrix}{K}_{i} \\ {K}_{i + 1}\end{matrix} ] \qquad [ Math . 1 ]$$

$$Z {v}_{i , i + 1} = {f}_{cat} ( {V}_{i} , {V}_{i + 1} ) = [ \begin{matrix}{V}_{i} \\ {V}_{i + 1}\end{matrix} ]$$

Next, the merging unit 11b performs conversion (merging processing) on the concatenation information (matrix) by using learned merging conversion information (Wk_{i,i+1}, bk_{i,i+1}, Wv_{i,i+1}, bv_{i,i+1}) (Linear layer learned parameters), and generates merging information (Z′k_{i,i+1}, Z′v_{i,i+1}). Thereafter, the merging unit 11b stores the generated merging information in the KV cache. The merging processing can be expressed as Math. 2. In Math. 2, flinear( ) represents the merging processing.

$${Z}^{′} {k}_{i , i + 1} = {f}_{l i n e a r} ( Z {k}_{i , i + 1} , {Wk}_{i , i + 1} , {bk}_{i , i + 1} ) = W {k}_{i , i + 1}^{T} \cdot {Zk}_{i , i + 1} + b {k}_{i , i + 1} \qquad [ Math . 2 ]$$

$${Z}^{′} {v}_{i , i + 1} = {f}_{l i n e a r} ( Z {v}_{i , i + 1} , {Wv}_{i , i + 1} , {bv}_{i , i + 1} ) = W {v}_{i , i + 1}^{T} \cdot {Zv}_{i , i + 1} + b {v}_{i , i + 1}$$

### <Unmerging Unit>

The unmerging unit 11c first acquires merging information stored in the KV cache. Next, the unmerging unit 11c performs conversion (unmerging processing) on the acquired merging information by using the learned unmerging conversion information (W′k_{i,i+1}, b′k_{i,i+1}, W′v_{i,i+1}, b′v_{i,i+1}) (Linear layer learned parameters), and generates pieces of second merging target information (predicted key vector K′ and value vector V′) to be used respectively in the target transformer blocks Li and Li+1. The unmerging processing can be expressed as Math. 3 and Math. 4.

$${K}_{i , i + 1}^{′} = {f}_{l i n e a r} ( {Z}^{′} {k}_{i , i + 1} , {W}^{′} {k}_{i , i + 1} , {b}^{′} {k}_{i , i + 1} ) = W {k}_{i , i + 1}^{T} \cdot {Z}^{′} {k}_{i , i + 1} + {b}^{′} {k}_{i , i + 1} \qquad [ Math . 3 ]$$

$$[ \begin{matrix}{K}_{i}^{′} \\ {K}_{i + 1}^{′}\end{matrix} ] = {K}_{i , i + 1}^{′}$$

$${V}_{i , i + 1}^{′} = ( {Z}^{′} {v}_{i , i + 1} , {W}^{′} {v}_{i , i + 1} , {b}^{′} {v}_{i , i + 1} ) = W {v}_{i , i + 1}^{T} \cdot {Z}^{′} {v}_{i , i + 1} + {b}^{′} {v}_{i , i + 1} \qquad [ Math . 4 ]$$

$$[ \begin{matrix}{V}_{i}^{′} \\ {V}_{i + 1}^{′}\end{matrix} ] = {V}_{i , i + 1}^{′}$$

Thereafter, the merging unit 11b executes the transformer blocks by using the pieces of second merging target information (key vector and value vector), and then newly generates merging information by using pieces of new merging target information (key vector and value vector) respectively associated to the target transformer blocks Li and Li+1.

The merging processing and the unmerging processing are not limited to the processing using the learned merging conversion information and the learned unmerging conversion information described above. The merging processing may use, for example, averaging processing. The averaging processing favg( ) can be expressed as Math. 5.

$${Z}^{′} {k}_{i , i + 1} = {f}_{a v g} ( {K}_{i} , {K}_{i + 1} ) = 0.5 \cdot {K}_{i} + 0.5 \cdot {K}_{i + 1} \qquad [ Math . 5 ]$$

### <Specific Example of Inference>

FIG. 6 is a diagram for explaining an example of inference in detail. The inference unit 11 will be described in chronological order by using steps 1, 2, and 3 in FIG. 6. In the example of FIG. 6, in order to make the description easy to understand, a case where the adjacent transformer blocks Li and Li+1 are targeted will be described as an example. However, the transformer blocks may not be adjacent to each other.

The example of FIG. 6 is a case where K and V associated to the past three tokens are stored in the KV cache.

In step 1 (first execution (prefill)), first, the transformer execution unit 11a of the inference unit 11 is executed as usual. Next, in step 1, the merging unit 11b acquires K and V, which are execution results of each of the target transformer blocks Li and Li+1 of the transformer execution unit 11a. That is, pieces of first merging target information 22c (key vector (K) and value vector (V)) are acquired that are used respectively in the target transformer blocks Li and Li+1.

Next, in step 1, the merging unit 11b concatenates the first merging target information 22c of the transformer block Li and the first merging target information 22c of the transformer block Li+1 to generate concatenation information. Next, in step 1, the merging unit 11b performs conversion (merging processing) on the concatenation information by using the learned merging conversion information 23a to generate the merging information 22d. Next, in step 1, the merging unit 11b stores the generated merging information 22d in the KV cache 22.

Next, in step 2 (inference of the second and subsequent tokens (decode)), the unmerging unit 11c performs conversion (unmerging processing) on the merging information 22d acquired from the KV cache by using the learned unmerging conversion information (Linear layer), and generates the pieces of second merging target information 22e (predicted key vector (K) and value vector (V) indicated by bold line frames in FIG. 6) to be used respectively in the target transformer blocks Li and Li+1.

Next, in step 3, after calculation of the Attention processing (execution of the transformer execution unit 11a by using the pieces of second merging target information (key vector and value vector)), the merging unit 11b generates new merging information 22d by using pieces of new merging target information (key vector (K) and value vector (V)) respectively associated to the target transformer blocks Li and Li+1. Next, in step 3, the merging unit 11b stores the generated new merging information 22d in the KV cache.
The calibration unit will be described.

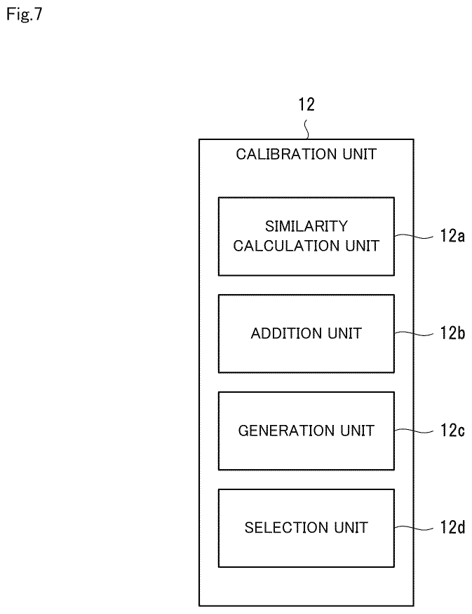

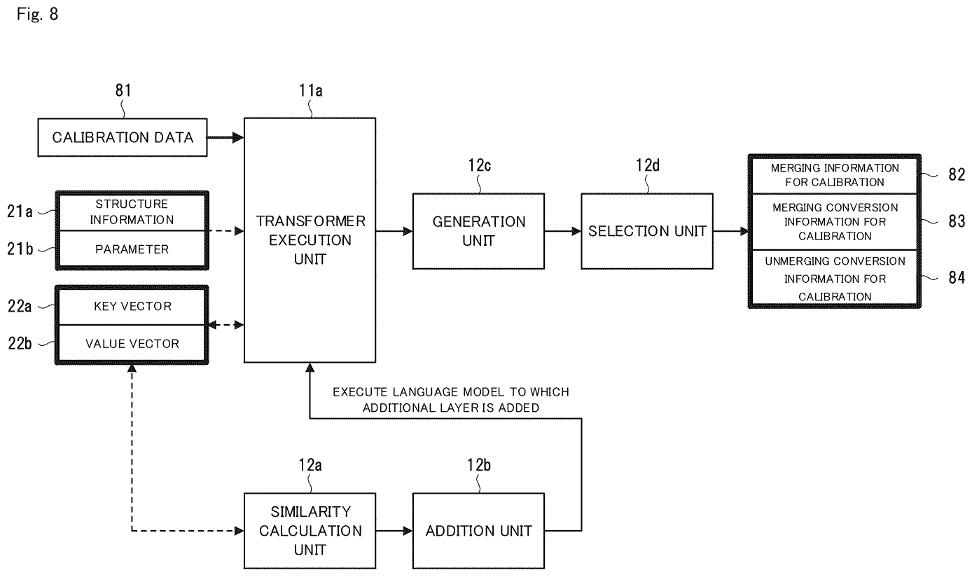

FIGS. 7 and 8 are diagrams for explaining an example of the calibration unit. The calibration unit 12 determines a targeted plurality of transformer blocks (layers) to be merged. However, although it is possible to merge a plurality of layers, if the number of layers increases (the number of layers to be merged increases), accuracy may deteriorate.

Thus, the calibration unit 12 calculates similarity between the KV caches in advance by using the key vector and the value vector of the KV cache of each of the plurality of transformer blocks, and determines the transformer blocks (layer) to be merged, based on the similarity.

As illustrated in FIGS. 7 and 8, the calibration unit 12 includes a similarity calculation unit 12a (similarity calculation means), an addition unit 12b (addition means), a generation unit 12c (generation means), and a selection unit 12d (selection means).

The similarity calculation unit 12a executes the transformer execution unit (language model) 11a by using calibration data 81 prepared in advance, generates pieces of merging target information for calibration (the key vector 22a and the value vector 22b) of the respective transformer blocks, and calculates similarity by using the pieces of merging target information for calibration.

The calibration data is, for example, data of about 10 to 100 samples. However, the number of samples is not limited to the number described above.

As the similarity, for example, it is conceivable to use an index such as Cosine similarity or Kullback-Leibler (KL) divergence. However, calculation of the similarity is not limited to the above-described index.

The addition unit 12b determines target transformer blocks, based on the similarity. Specifically, first, in a case where the similarity between the KV caches is higher than a preset threshold, the addition unit 12b determines transformer blocks associated to the KV caches having a high similarity as the target transformer blocks.

Next, the addition unit 12b adds, to the KV caches associated to the target transformer blocks, merging conversion information for calibration 83 (Linear layer) and unmerging conversion information for calibration 84 (Linear layer) to be used in the target transformer blocks, that is, the additional layer 23.

After adding the additional layer 23 (merging conversion information for calibration 83 and unmerging conversion information for calibration 84), the generation unit 12c executes the language model a plurality of times by using the calibration data, and generates the merging information for calibration 82 associated to the target transformer blocks each time the language model is executed.

Based on recognition accuracy of the language model, the selection unit 12d selects the merging information for calibration 82, the merging conversion information for calibration 83, and the unmerging conversion information for calibration 84 with which the recognition accuracy is the highest.

As the recognition accuracy, an average accuracy rate or perplexity of a plurality of problems in an evaluation data set is generally used.

The merging information for calibration 82, the merging conversion information for calibration 83, and the unmerging conversion information for calibration 84 selected by the calibration unit 12 are set as initial parameters before learning.
The learning unit will be described.

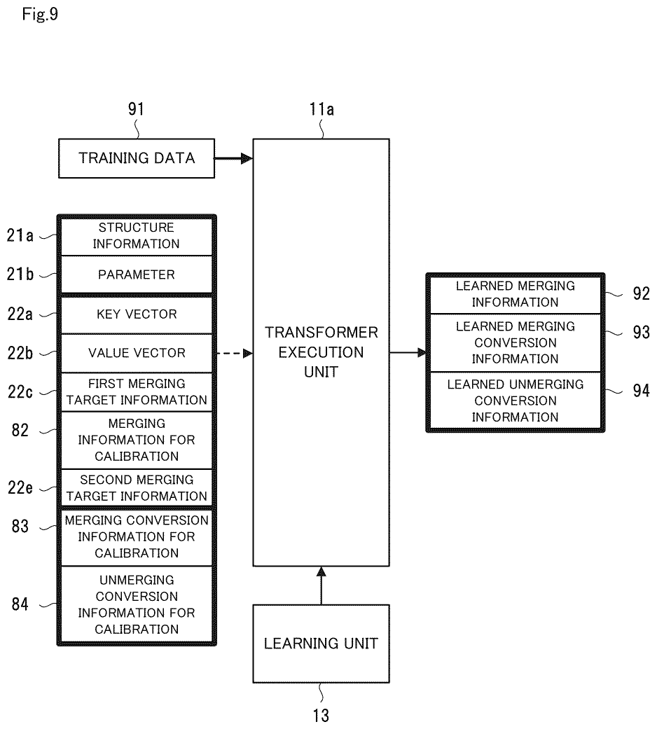

FIG. 9 is a diagram for explaining an example of the learning unit. The learning unit 13 learns merging conversion information (Linear layer) and unmerging conversion information (Linear layer) in order to improve the recognition accuracy of the language model.

The learning is performed, for example, for several hours to several days by using training data. The merging conversion information for calibration 83 and the unmerging conversion information for calibration 84 are used as initial parameters.

The learning unit 13 first executes the transformer execution unit (language model) 11a by using training data 91 and calculates an error (loss) between a ground truth label associated to the training data 91 and an execution result of the language model. Next, the learning unit 13 updates merging conversion information for learning and unmerging conversion information for learning by error back propagation processing by using the error.

Specifically, in a case where the error is equal to or less than a preset threshold (in a case where the loss is sufficiently decreased), the merging conversion information for learning is set as learned merging conversion information 93, and the unmerging conversion information for learning is set as learned unmerging conversion information 94.

### [Apparatus Operation]

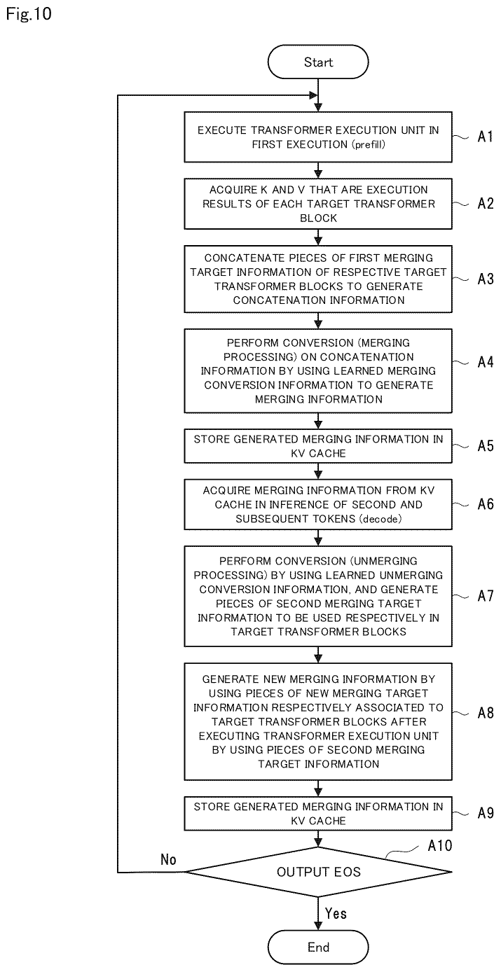

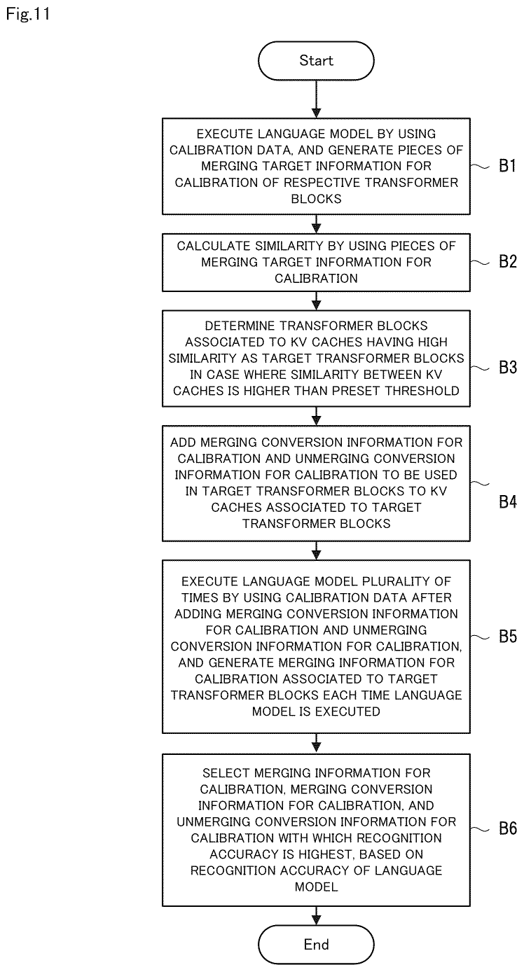

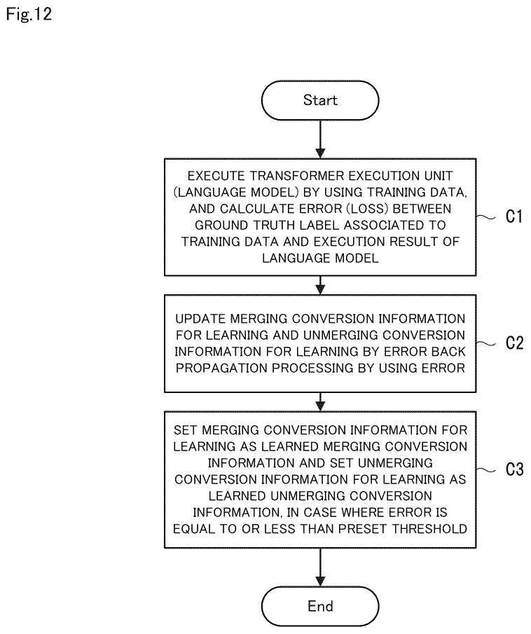

Next, operation of the information processing apparatus in the example embodiment will be described with reference to FIGS. 10, 11, and 12. FIG. 10 is a diagram for explaining an example of merging and unmerging operation. FIG. 11 is a diagram for explaining an example of calibration operation. FIG. 12 is a diagram for explaining an example of learning operation.

The drawings will be appropriately referred to in the following description. In the example embodiment, inference, calibration, and learning are performed by operating the information processing apparatus. Thus, the description of an inference method, a calibration method, and a learning method in the example embodiment is replaced with the following description of the operation of the information processing apparatus.

### <Merging and Unmerging Operation in Inference>

In the first execution (prefill), first, the transformer execution unit 11a of the inference unit 11 is executed as usual (step A1).

Next, the merging unit 11b acquires the pieces of first merging target information 22c (key vector (K) and value vector (V)) that are execution results of the respective target transformer blocks of the transformer execution unit 11a (step A2).

Next, the merging unit 11b concatenates the pieces of first merging target information 22c of the respective transformer blocks to generate concatenation information (step A3).

Next, the merging unit 11b performs conversion (merging processing) on the concatenation information by using the merging conversion information 23a learned to generate the merging information 22d (step A4). Next, the merging unit 11b stores the generated merging information 22d in the KV cache 22 (step A5).

Next, in the inference of the second and subsequent tokens (decode), the unmerging unit 11c acquires the merging information 22d from the KV cache (step A6).

Next, the unmerging unit 11c performs conversion (unmerging processing) by using the learned unmerging conversion information (Linear layer), and generates the pieces of second merging target information 22e (predicted key vector (K) and value vector (V) indicated by bold line frames in FIG. 6) to be used respectively in the target transformer blocks (step A7).

Next, after calculating Attention (executing the transformer execution unit 11a by using the second merging target information (key vector and value vector)), the merging unit 11b generates new merging information 22d by using pieces of new merging target information (key vector (K) and value vector (V)) respectively associated to the target transformer blocks (step A8).

Next, the merging unit 11b stores the generated new merging information 22d in the KV cache (step A9).

Thereafter, in a case where the EOS (token indicating the end of a sentence) is output (step A10: Yes), the processing is ended. On the other hand, in a case where the EOS is not output (step A10: No), the processing is repeated until the EOS is output.

### <Calibration Operation>

The transformer execution unit (language model) 11a is executed by use of the calibration data 81 prepared in advance, and pieces of merging target information for calibration (the key vector 22a and the value vector 22b) of the respective transformer blocks are generated (step B1).

Next, the similarity calculation unit 12a calculates similarity by using the pieces of merging target information for calibration (step B2).

Next, the addition unit 12b determines target transformer blocks, based on the similarity (step B3). Specifically, in step B3, in a case where the similarity between the KV caches is higher than the preset threshold, the addition unit 12b determines transformer blocks associated to the KV caches having a high similarity as the target transformer blocks.

Next, the addition unit 12b adds, to the KV caches associated to the target transformer blocks, the merging conversion information for calibration 83 (Linear layer) and the unmerging conversion information for calibration 84 (Linear layer) to be used in the target transformer blocks (step B4).

Next, after adding the merging conversion information for calibration 83 and the unmerging conversion information for calibration 84, the generation unit 12c executes the language model a plurality of times by using the calibration data, and generates the merging information for calibration 82 associated to the target transformer blocks each time the language model is executed (step B5).

Next, based on the recognition accuracy of the language model, the selection unit 12d selects the merging information for calibration 82, the merging conversion information for calibration 83, and the unmerging conversion information for calibration 84 with which the recognition accuracy is the highest (step B6).

The merging information for calibration 82, the merging conversion information for calibration 83, and the unmerging conversion information for calibration 84 selected by the calibration unit 12 are set as initial parameters before learning.

### <Learning Operation>

The learning unit 13 first executes the transformer execution unit (language model) 11a by using the training data 91 and calculates an error (loss) between a ground truth label associated to the training data 91 and an execution result of the language model (step C1).

Next, the learning unit 13 updates the merging conversion information for learning and the unmerging conversion information for learning by error back propagation processing by using the error (step C2).

Next, in a case where the error is equal to or less than the preset threshold (in a case where the loss is sufficiently decreased), the learning unit 13 sets the merging conversion information for learning as the learned merging conversion information 93 and sets the unmerging conversion information for learning as the learned unmerging conversion information 94 (step C3).

### Effects of Example Embodiment

As described above, according to the example embodiment, it is possible to make the key vector and the value vector used in the target transformer block common by compressing the key vector and the value vector by the merging processing, so that the usage amount of the memory used in the language model can be reduced. Furthermore, the amount of calculation of the language model can also be reduced.

### [Program]

A program in the example embodiment is only required to be a program that causes a computer to execute steps A1 to A10 illustrated in FIG. 10, steps B1 to B6 illustrated in FIG. 11, and steps C1 to C3 illustrated in FIG. 12. The program is installed and executed in the computer, whereby the information processing apparatus and information processing method in the example embodiment can be implemented. In this case, a processor of the computer functions as the inference unit 11 (transformer execution unit 11a, merging unit 11b, and unmerging unit 11c), the calibration unit 12 (similarity calculation unit 12a, addition unit 12b, generation unit 12c, and selection unit 12d), and the learning unit 13, and performs processing.

The program in the example embodiment may be executed by a computer system including a plurality of computers. In this case, for example, each computer may function as any of the inference unit 11 (transformer execution unit 11a, merging unit 11b, and unmerging unit 11c), the calibration unit 12 (similarity calculation unit 12a, addition unit 12b, generation unit 12c, and selection unit 12d), and the learning unit 13.

### [Physical Configuration]

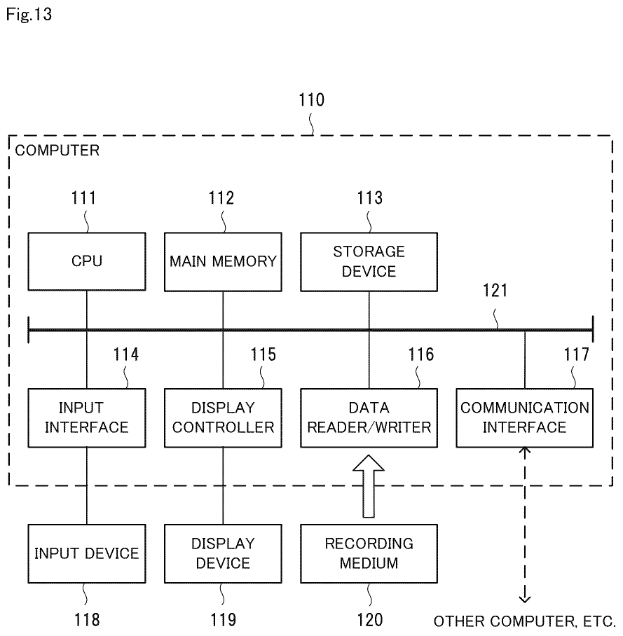

Here, the computer that implements the information processing apparatus by executing the program in the example embodiment will be described with reference to FIG. 13. FIG. 13 is a diagram for explaining an example of the computer that implements the information processing apparatus in the example embodiment.

As illustrated in FIG. 13, a computer 110 includes a CPU 111, a main memory 112, a storage device 113, an input interface 114, a display controller 115, a data reader/writer 116, and a communication interface 117. These units are connected to each other via a bus 121 so as to be able to perform data communication with each other. The computer 110 may include a GPU or an FPGA in addition to the CPU 111 or instead of the CPU 111.

The CPU 111 loads the program in the example embodiment, the program being stored in the storage device 113 and constituted by codes, into the main memory 112, and executes the codes in a predetermined order to perform various computations. The main memory 112 is typically a volatile storage device such as a Dynamic Random Access Memory (DRAM).

The program in the example embodiment is provided in a state of being stored in a computer-readable recording medium 120. The program in the example embodiment may be distributed on the Internet connected via the communication interface 117.

Specific examples of the storage device 113 include a semiconductor storage device, such as a flash memory, in addition to a hard disk drive. The input interface 114 mediates data transmission between the CPU 111 and an input device 118 such as a keyboard and a mouse. The display controller 115 is connected to a display device 119, and controls display on the display device 119.

The data reader/writer 116 mediates data transmission between the CPU 111 and the recording medium 120, and reads a program from the recording medium 120 and writes a processing result in the computer 110 into the recording medium 120. The communication interface 117 mediates data transmission between the CPU 111 and another computer.

Specific examples of the recording medium 120 include a general-purpose semiconductor storage device such as Compact Flash (CF) (registered trademark) or Secure Digital (SD), a magnetic recording medium such as a Flexible Disk, and an optical recording medium such as a Compact Disk Read Only Memory (CD-ROM).

The information processing apparatus 10 in the example embodiment can also be implemented by use of hardware corresponding to each unit, for example, an electronic circuit, instead of a computer in which a program is installed. Furthermore, a part of the information processing apparatus 10 may be implemented by a program, and the remaining part may be implemented by hardware. In the example embodiment, the computer is not limited to the computer illustrated in FIG. 13.

### Supplementary Note

With regard to the above example embodiment, the following supplementary notes are further disclosed. A part or whole of the example embodiment described above can be expressed by the following (Supplementary Note 1) to (Supplementary Note 21), but is not limited to the following description.

### (Supplementary Note 1)

An information processing apparatus that is a language model including a plurality of transformer blocks,
the information processing apparatus including
a merging unit for executing merging processing on pieces of first merging target information having a key vector and a value vector to be used in target transformer blocks among the plurality of transformer blocks by using learned merging conversion information, and generating merging information obtained by making the pieces of first merging target information common, and
an unmerging unit for executing, in next inference, unmerging processing on the merging information by using learned unmerging conversion information, and generating pieces of second merging target information to be used respectively in the target transformer blocks.

### (Supplementary Note 2)

The information processing apparatus according to Supplementary Note 1, in which
the merging unit generates new merging information by using pieces of new first merging target information associated to the target transformer blocks after the transformer blocks are executed by using the pieces of second merging target information.

### (Supplementary Note 3)

The information processing apparatus according to Supplementary Note 1, in which
in the merging processing, linear transformation processing using the learned merging conversion information or averaging processing is executed.

### (Supplementary Note 4)

The information processing apparatus according to Supplementary Note 1, in which
in the unmerging processing, linear transformation processing using the learned unmerging conversion information is executed.

### (Supplementary Note 5)

The information processing apparatus according to Supplementary Note 1, including
a similarity calculation unit for executing the language model by using calibration data, generating pieces of merging target information for calibration of the respective transformer blocks, and calculating similarity by using the pieces of merging target information for calibration,
an addition unit for determining the target transformer blocks, based on the similarity, and adding merging conversion information for calibration and unmerging conversion information for calibration,
a generation unit for executing the language model a plurality of times by using the calibration data, after the merging conversion information for calibration and the unmerging conversion information for calibration are added, and generating merging information for calibration associated to the target transformer blocks each time the language model is executed, and
a selection unit for selecting, based on recognition accuracy of the language model, the merging information for calibration, the merging conversion information for calibration, and the unmerging conversion information for calibration with which the recognition accuracy is highest.

### (Supplementary Note 6)

The information processing apparatus according to Supplementary Note 5, including
a learning means for executing the language model by using training data, calculating an error between a ground truth label associated to the training data and an execution result of the language model, and updating merging conversion information for learning and unmerging conversion information for learning by error back propagation processing by using the error.

### (Supplementary Note 7)

The information processing apparatus according to Supplementary note 6, in which
the learning means sets the merging conversion information for learning as the learned merging conversion information and sets the unmerging conversion information for learning as the learned unmerging conversion information in a case where the error is equal to or less than a preset threshold.

### (Supplementary Note 8)

An inference method including,
by a computer that executes a language model including a plurality of transformer blocks,
executing merging processing on pieces of first merging target information having a key vector and a value vector to be used in target transformer blocks among the plurality of transformer blocks by using learned merging conversion information, and generating merging information obtained by making the pieces of first merging target information common, and
executing, in next inference, unmerging processing on the merging information by using learned unmerging conversion information, and generating pieces of second merging target information to be used respectively in the target transformer blocks.

### (Supplementary Note 9)

The inference method according to Supplementary Note 8, further including,
by the computer,
generating new merging information by using pieces of new first merging target information associated to the target transformer blocks after the transformer blocks are executed by using the pieces of second merging target information.

### (Supplementary Note 10)

The inference method according to Supplementary Note 8, further including,
in the merging processing, executing linear transformation processing using the learned merging conversion information or averaging processing.

### (Supplementary Note 11)

The inference method according to Supplementary Note 8, further including,
in the unmerging processing, executing linear transformation processing using the learned unmerging conversion information.

### (Supplementary Note 12)

The inference method according to Supplementary Note 8, further including,
by the computer,
executing the language model by using calibration data, generating pieces of merging target information for calibration of the respective transformer blocks, and calculating similarity by using the pieces of merging target information for calibration,
determining the target transformer blocks, based on the similarity, and adding merging conversion information for calibration and unmerging conversion information for calibration,
executing the language model a plurality of times by using the calibration data, after the merging conversion information for calibration and the unmerging conversion information for calibration are added, and generating merging information for calibration associated to the target transformer blocks each time the language model is executed, and
selecting, based on recognition accuracy of the language model, the merging information for calibration, the merging conversion information for calibration, and the unmerging conversion information for calibration with which the recognition accuracy is highest.

### (Supplementary Note 13)

The inference method according to Supplementary Note 12, further including,
by the computer,
executing the language model by using training data, calculating an error between a ground truth label associated to the training data and an execution result of the language model, and updating merging conversion information for learning and unmerging conversion information for learning by error back propagation processing by using the error.

### (Supplementary Note 14)

The inference method according to Supplementary Note 13, further including,
by the computer,
setting the merging conversion information for learning as the learned merging conversion information and setting the unmerging conversion information for learning as the learned unmerging conversion information in a case where the error is equal to or less than a preset threshold.

### (Supplementary Note 15)

A computer-readable recording medium recording a program
for causing a computer that executes a language model including a plurality of transformer blocks to
execute merging processing on pieces of first merging target information having a key vector and a value vector to be used in target transformer blocks among the plurality of transformer blocks by using learned merging conversion information, and generate merging information obtained by making the pieces of first merging target information common, and
execute, in next inference, unmerging processing on the merging information by using learned unmerging conversion information, and generate pieces of second merging target information to be used respectively in the target transformer blocks.

### (Supplementary Note 16)

The computer-readable recording medium according to Supplementary Note 15, in which
the computer is caused to
generate new merging information by using pieces of new first merging target information associated to the target transformer blocks after the transformer blocks are executed by using the pieces of second merging target information.

### (Supplementary Note 17)

The computer-readable recording medium according to Supplementary Note 15, in which
in the merging processing, linear transformation processing using the learned merging conversion information or averaging processing is executed.

### (Supplementary Note 18)

The computer-readable recording medium according to Supplementary Note 15, in which
in the unmerging processing, linear transformation processing using the learned unmerging conversion information is executed.

### (Supplementary Note 19)

The computer-readable recording medium according to Supplementary Note 15, in which
the computer is caused to
execute the language model by using calibration data, generate pieces of merging target information for calibration of the respective transformer blocks, and calculate similarity by using the pieces of merging target information for calibration,
determine the target transformer blocks, based on the similarity, and add merging conversion information for calibration and unmerging conversion information for calibration,
execute the language model a plurality of times by using the calibration data, after the merging conversion information for calibration and the unmerging conversion information for calibration are added, and generate merging information for calibration associated to the target transformer blocks each time the language model is executed, and
select, based on recognition accuracy of the language model, the merging information for calibration, the merging conversion information for calibration, and the unmerging conversion information for calibration with which the recognition accuracy is highest.

### (Supplementary Note 20)

The computer-readable recording medium according to Supplementary Note 19, in which
the computer is caused to
execute the language model by using training data, calculate an error between a ground truth label associated to the training data and an execution result of the language model, and update merging conversion information for learning and unmerging conversion information for learning by error back propagation processing by using the error.

### (Supplementary Note 21)

The computer-readable recording medium according to Supplementary Note 20, in which
the computer is caused to
set the merging conversion information for learning as the learned merging conversion information and set the unmerging conversion information for learning as the learned unmerging conversion information in a case where the error is equal to or less than a preset threshold.

While the invention has been particularly shown and described with reference to the example embodiment, the invention is not limited to the above-described example embodiment. It will be understood by those of ordinary skill in the art that various changes in form and details may be made therein without departing from the spirit and scope of the invention as defined by the claims.

### INDUSTRIAL APPLICABILITY

According to the above description, it is possible to reduce the usage amount of the memory used in the language model and reduce the amount of calculation. It is also useful in the field of language models.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

1. An information processing apparatus that is a language model including a plurality of transformer blocks,
the information processing apparatus comprising:
at least one memory storing instructions; and
at least one processor configured to execute the instructions to:
execute merging processing on pieces of first merging target information having a key vector and a value vector to be used in target transformer blocks among the plurality of transformer blocks by using learned merging conversion information, and generate merging information obtained by making the pieces of first merging target information common; and
execute, in next inference, unmerging processing on the merging information by using learned unmerging conversion information, and generate pieces of second merging target information to be used respectively in the target transformer blocks.

2. The information processing apparatus according to claim 1, wherein
the one or more processors further:
generates new merging information by using pieces of new first merging target information associated to the target transformer blocks after the transformer blocks are executed by using the pieces of second merging target information.

3. The information processing apparatus according to claim 1, wherein
in the merging processing, linear transformation processing using the learned merging conversion information or averaging processing is executed.

4. The information processing apparatus according to claim 1, wherein
in the unmerging processing, linear transformation processing using the learned unmerging conversion information is executed.

5. The information processing apparatus according to claim 1, comprising:
the one or more processors further:
executes the language model by using calibration data, generating pieces of merging target information for calibration of the respective transformer blocks, and calculating similarity by using the pieces of merging target information for calibration;
determines the target transformer blocks, based on the similarity, and adds merging conversion information for calibration and unmerging conversion information for calibration;
executes the language model a plurality of times by using the calibration data, after the merging conversion information for calibration and the unmerging conversion information for calibration are added, and generates merging information for calibration associated to the target transformer blocks each time the language model is executed; and
selects, based on recognition accuracy of the language model, the merging information for calibration, the merging conversion information for calibration, and the unmerging conversion information for calibration with which the recognition accuracy is highest.

6. The information processing apparatus according to claim 5, comprising
the one or more processors further:
executes the language model by using training data, calculates an error between a ground truth label associated to the training data and an execution result of the language model, and updates merging conversion information for learning and unmerging conversion information for learning by error back propagation processing by using the error.

7. The information processing apparatus according to claim 6, wherein
the one or more processors further:
sets the merging conversion information for learning as the learned merging conversion information and sets the unmerging conversion information for learning as the learned unmerging conversion information in a case where the error is equal to or less than a preset threshold.

8. An inference method comprising,
by a computer that executes a language model including a plurality of transformer blocks,
executing merging processing on pieces of first merging target information having a key vector and a value vector to be used in target transformer blocks among the plurality of transformer blocks by using learned merging conversion information, and generating merging information obtained by making the pieces of first merging target information common, and
executing, in next inference, unmerging processing on the merging information by using learned unmerging conversion information, and generating pieces of second merging target information to be used respectively in the target transformer blocks.

9. A non-transitory computer-readable recording medium recording a program
for causing a computer that executes a language model including a plurality of transformer blocks to
execute merging processing on pieces of first merging target information having a key vector and a value vector to be used in target transformer blocks among the plurality of transformer blocks by using learned merging conversion information, and generate merging information obtained by making the pieces of first merging target information common, and
execute, in next inference, unmerging processing on the merging information by using learned unmerging conversion information, and generate pieces of second merging target information to be used respectively in the target transformer blocks.
